(19) United States
(12) Patent Application Publication
(10) Pub. No.: US 2017/0021212 A1
(43) Pub. Date: Jan. 26, 2017

(54) Extinguisher Assembly

(71) Applicant: Mehoe Enterprise Inc., Carlton Place (CA)

(72) Inventors: Matthew Perry, Arnprior (CA); Michael McManus, Arnprior (CA)

(73) Assignee: Mehoe Enterprise Inc., Carlton Place, Ontario (CA)

(21) Appl. No.: 15/302,608

(22) PCT Filed: Apr. 7, 2015
(86) PCT No.: PCT/CA2015/050280

§ 371 Date: Oct. 7, 2016

Related U.S. Application Data
(60) Provisional application No. 61/976,122, filed on Apr. 7, 2014.

(51) Int. Cl. A62C 35/13; A62C 35/02; A62C 37/38; A62C 3/00

(52) U.S. Cl. CPC A62C 35/13; A62C 3/00; A62C 35/023; A62C 37/38; A62C 37/48

(57) ABSTRACT

A fire extinguisher assembly is disclosed, providing a connection from a standard fire extinguisher tank through to a housing with dispersion vents. A spray nozzle is secured within the housing for dispersing the fire retardant agent through the dispersion vents, and a connecting means is disclosed, positioned on the housing for securing the extinguisher assembly to a structure. An adapter further comprised of a first end fastened to the spray nozzle and a second end connected to an extinguisher tank is also disclosed to provide the said connection, therefore the fire retardant agent is expelled directly from the extinguisher tank through to the dispersion vents.

### FIELD OF THE INVENTION

The present invention relates to the field of extinguishers, and more specifically to an extinguisher assembly to combine a fire extinguisher to a fire detector.

### BACKGROUND

Extinguishers, and more specifically fire extinguishers, have been around for well over a century. Various types of fire extinguishers exist today, including dry chemical, foam, water, carbon dioxide to name a few. Invariably, these extinguishers are located in various locations throughout homes and buildings to provide easy access in case that a fire breaks out.

Many inventions have been devised in order to perfect the contents of the fire extinguishers, and to enable them to be affixed inside a container or on a wall or other similar structure for easy access. Patents such as U.S. Pat. No. 5,315,292 (Prior), U.S. Pat. No. 6,244,353 (Greer), and U.S. Pat. No. 7,385,480 (Fitzpatrick) are examples that illustrate various combinations of fire/smoke detectors and fire extinguishers.

Specifically, Prior's device discloses a ceiling mountable smoke detector which is connected to a pressurized canister of fire extinguishing powder. A heat sensing switch will open and close a valve in order to allow the canister to expel the fire extinguishing powder into the room. However, there are a few downfalls to this device. First, as the canister is located vertically, it takes up a substantial amount of room in the ceiling such that not all ceilings will allow for it to sit properly or even be installable. Second, Prior's device requires a connection to standard 120V AC power running through the ceiling. This type of device is not suitable for operation when the power has run out for an extended period of time, and a fire erupts in the room.

Meanwhile, Greer discloses another type of device whereby a canister for dispersing a fire retardant agent is installed vertically, with an attached propeller to disperse the agent secured at its base. A detector is located within the device and connects to the extinguisher. Greer's device has similar shortcomings. First, the canister is vertically aligned such that it takes an inconvenient amount of room in the ceiling. Greeg proposes that the device be installed outside of the ceiling (thus protruding therefrom); however, this solution is inconvenient as well as, it is not ergonomic and certainly not visually pleasing to see in a room. Second, it comprises exit doors which can be cumbersome and will also prevent the fire retardant agent to extinguish fire that is outside of the reach of the doors.

Fitzpatrick discloses a different, albeit similar device whereby a heat retardant agent is enclosed within a heat-sensitive membrane. Therefore, when the heat-sensitive membrane becomes sufficiently hot and melts, it physically allows for the fire retardant agent to be dispersed over the immediate area. Fitzpatrick's device has its own shortcomings which are enumerated below. First, when the fire retardant agent is released, it simply falls down by virtue of gravity. Therefore, it cannot extinguish a large fire throughout a room through dispersion vents. Second, Fitzpatrick's device is more suited for an immediate heater that perhaps overheats adjacent objects or itself; it cannot be installed in a large room and expected to put out large fire.

As it can be seen, the aforementioned devices have some shortcomings which need to be addressed. Specifically, a device is needed that can take a pressurized fire retardant agent and disperse it properly throughout a room without the need of a motor or other motor-driven mechanical assistance, which can also be properly fit into existing ceiling structures without compromising the ergonomics of a room or the physical constraints of its ceiling, is needed. The device as described below is capable of doing such things.

### SUMMARY OF THE INVENTION

In an aspect, the present invention provides an extinguisher assembly for dispersing a fire retardant agent, comprising a housing further comprised of dispersion vents for re-directing the fire retardant agent; a spray nozzle secured within the housing for dispersing the fire retardant agent through the dispersion vents; a connecting means positioned on the housing for securing the extinguisher assembly to a structure, and an adapter further comprised of a first end fastened to the spray nozzle and a second end connected to an extinguisher tank; wherein the fire retardant agent is expelled directly from the extinguisher tank through to the dispersion vents.

### BRIEF DESCRIPTION OF THE DRAWINGS

The following figures serve to illustrate various embodiments of features of the invention. These figures are illustrative and are not intended to be limiting.

FIG. 1 is a perspective view of an extinguisher assembly, according to one embodiment of the present invention;

FIG. 2 is a perspective view of an extinguisher assembly fastened to a detector, according to one embodiment of the present invention;

FIG. 3 is a perspective view of an extinguisher assembly connected to both a detector and a extinguisher tank, according to one embodiment of the present invention;

FIG. 4 is a perspective view of the connection between the extinguisher tube, the tee tub, street elbow, the reducer and the spray nozzle, according to one embodiment of the present invention;

FIG. 5 is a perspective view of an extinguisher assembly fastened to a lower housing of a detector, according to one embodiment of the present invention;

FIG. 6 is a perspective view of a detector connected to a spacer of the extinguisher assembly, according to one embodiment of the present invention;

FIG. 7 is a perspective view of a first connecting member of an extinguisher assembly, according to one embodiment of the present invention;

FIG. 8 front view of a detector, according to one embodiment of the present invention;

FIG. 8a is a perspective of an upper housing of the extinguisher assembly, according to a second embodiment of the present invention;

FIG. 9 is a perspective view of an extinguisher assembly, according to a second embodiment of the present invention;

FIG. 10a is a perspective view of an extinguisher assembly without an upper housing according to a third embodiment of the present invention;

FIG. 10b is a perspective view of an extinguisher assembly according to a third embodiment of the present invention.

### DETAILED DESCRIPTION

The present invention will now be described more fully hereinafter with reference to the accompanying drawings, in which preferred and other embodiments of the invention are shown. No embodiment described below limits any claimed invention and any claimed invention may cover processes or apparatuses that are not described below. The claimed inventions are not limited to apparatuses or processes having all the features of any one apparatus or process described below or to features common to multiple or all of the apparatuses described below. It is possible that an apparatus or process described below is not an embodiment of any claimed invention. The applicants, inventors or owners reserve all rights that they may have in any invention claimed in this document, for example the right to claim such an invention in a continuing application and do not intend to abandon, disclaim or dedicate to the public any such invention by its disclosure in this document.

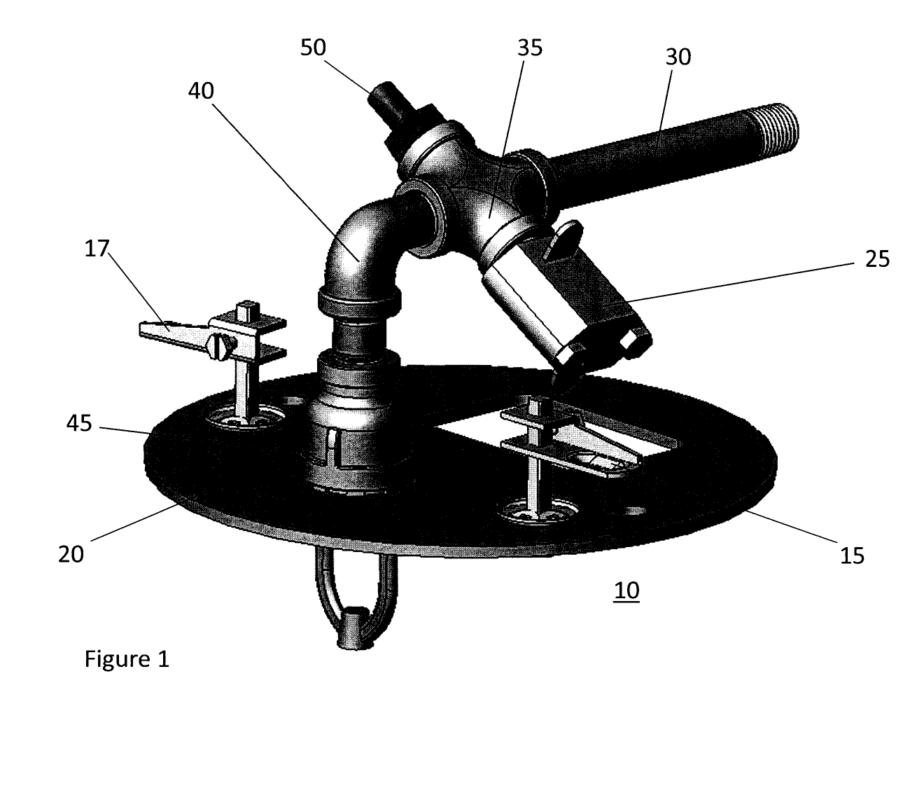

With reference to FIG. 1 and according to one embodiment of the present invention, an extinguisher assembly 10 is shown. The extinguisher assembly 10 is primarily comprised of a connecting means described herein as first and second connecting members 15, 17, spacer 20, pressure switch 25, extinguisher tube 30, tee tube 35, street elbow 40, reducer 45 and a spray nozzle 70. A Schrader valve 50 is also shown, connected to the tee tube 35 in order to pressurize the extinguisher tank (not shown). A worker skilled in the relevant art will appreciate that the Schrader valve 50 is well known in the art; however, this particular Schrader valve 50 and pressure switch 25 are loaded with sintered brass that acts as a filter in order to prevent the fire retardant agent from corroding either said Schrader valve 50 or pressure switch 25. When the extinguisher assembly 10 is activated, the extinguishing agent located in the tank (not shown) is expelled from said tank (not shown) and into the extinguisher tube 30, through the tee tub 35, into the street elbow 40 and through the reducer 45. The reducer 45 ultimately forces the agent into a spray nozzle 70, which sprays the agent outwards and is then dispersed and redirected to a larger area by means of redirecting slots (not shown). The pressure switch 25 is connected to the tee tube 25 and is utilized in order to detect pressure in the tank (not shown), such that if said pressure is too low, a blue light (not shown) connected to the battery (not shown) will light up in order to alert the occupant of the room that the tank (not shown) should be checked. Although the specific wiring circuitry is not shown, the pressure switch 25 is connected directly to the battery (not shown), which is in turn connected directly to the blue light (not shown) which protrudes from a lower housing (not shown) of the detector (not shown). The street elbow 40 is utilized in the extinguisher assembly 10 as it allows the redirection of the fire retardant agent from the horizontally-placed tank (not shown) to a vertical direction; in other words, downwards. This allows for the extinguisher assembly 10 to be placed in the ceiling in a horizontal position, as opposed to a vertical position. In order to affix the extinguisher assembly 10 to the ceiling of a structure, a hole is created in said ceiling and the tank (not shown) is inserted first. First and second connecting member 15, 17 will provide support for the extinguisher assembly 10 such that the spacer 20 is flush with the lower, visible section of the ceiling. Securing the extinguisher assembly 10 to the ceiling by means of first and second connecting members 15, 17 is also important as otherwise the tank (not shown) would unevenly tilt the extinguisher assembly 10 in its direction, unequally across the ceiling. The exact functioning of the first and second connecting members 15, 17 will be further described below.

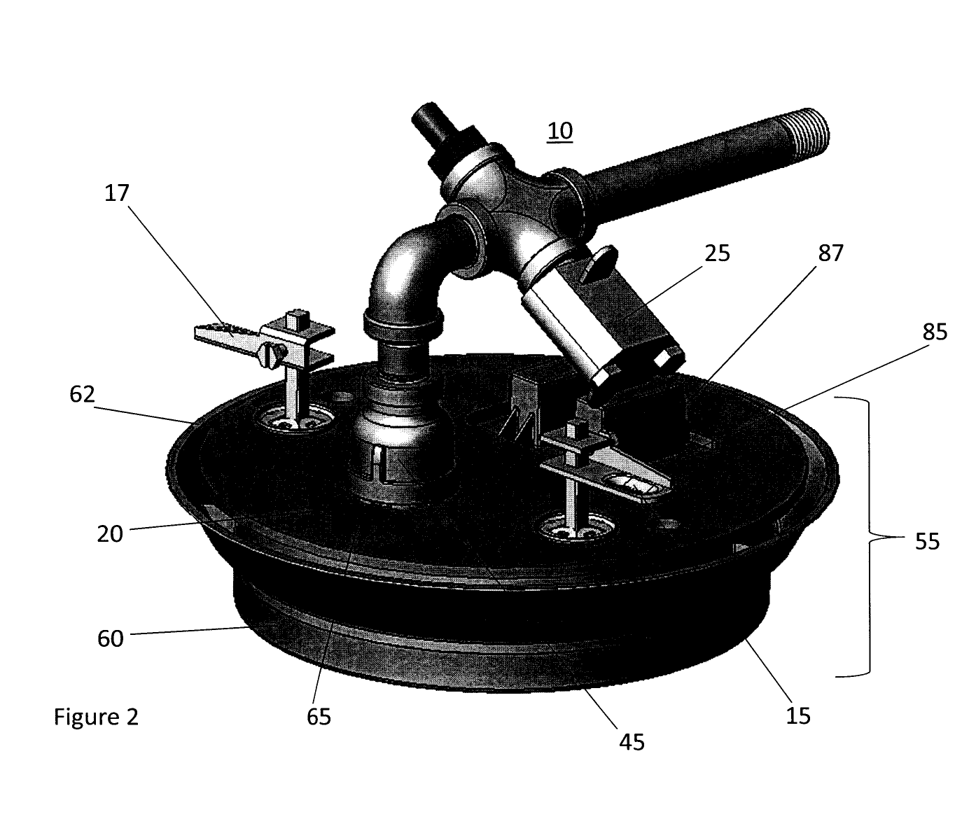

With reference to FIG. 2 and according to one embodiment of the present invention, the extinguisher assembly 10 is shown connected to a fire detector 55. The fire detector 55 is further comprised of an upper and lower housing 60, 62 and PCB (not shown) and LED unit (not shown). As was previously described, when the extinguisher assembly 10 is fastened to the ceiling, said ceiling will be located in between the spacer 20 which in turn is flush with an upper surface (not shown) of the lower housing 62, and the first and second connecting members 15, 17. The hole created in the ceiling is typically large enough to allow for the tank (not shown) and the extinguisher assembly 10 to be inserted within it. The battery 87 is shown protruding from a battery opening 85, which connects to both the PCB (not shown) and independently as a closed circuit to the blue light (not shown) and pressure switch 25. While the battery is utilized for this function, a worker skilled in the relevant art would also appreciate that a regular power cable could provide the necessary electricity to power the blue light (not shown) and PCB (not shown), especially where this is necessary for legal purposes. A worker skilled in the relevant art would further appreciate that while the battery 87 here is a standard 9V battery, said battery 87 could be replaced by a lithium ion battery, or other suitable battery that are well-known in the art.

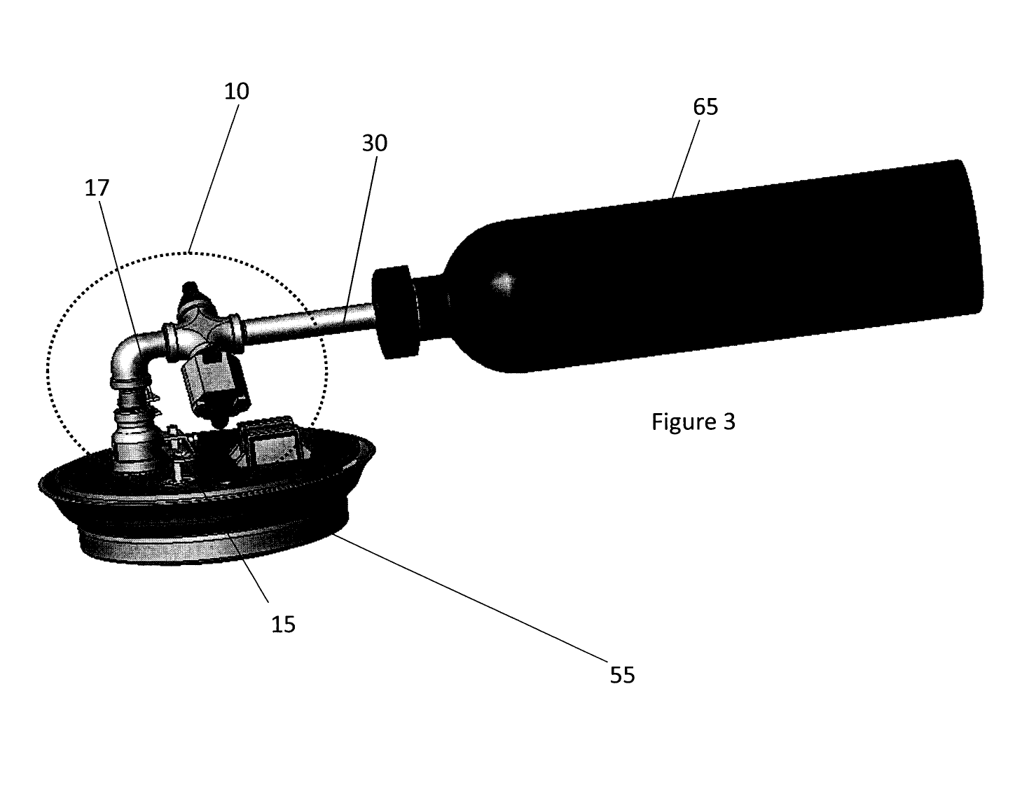

With reference to FIG. 3 and according to one embodiment of the present invention, the extinguisher assembly 10 is fastened at one end to the extinguisher tank 65, and at the opposing end to the detector 55. As is shown, the extinguisher tube 30 links the extinguisher assembly 10 to the tank 65, the functioning of said tank being very well known in the art. As was previously explained, when the detector 55 and extinguisher assembly 10 are positioned into a ceiling, the weight of the tank 65 makes it such that the detector and extinguisher assembly 10 need to be properly secured to the ceiling, which is done by means of first and second connecting members 15, 17. A worker skilled in the relevant art would appreciate that not every single extinguisher assembly 10 will require all the components of the detector 55. Indeed, as regulations require that the extinguisher assembly 10 cover a 16-foot radius, such that if multiple extinguisher assembly 10 are present, they do not require all of the parts of the detector 55 portion. Specifically, the extinguisher assembly 10 will simply require the detector 55 without the PCB (not shown).

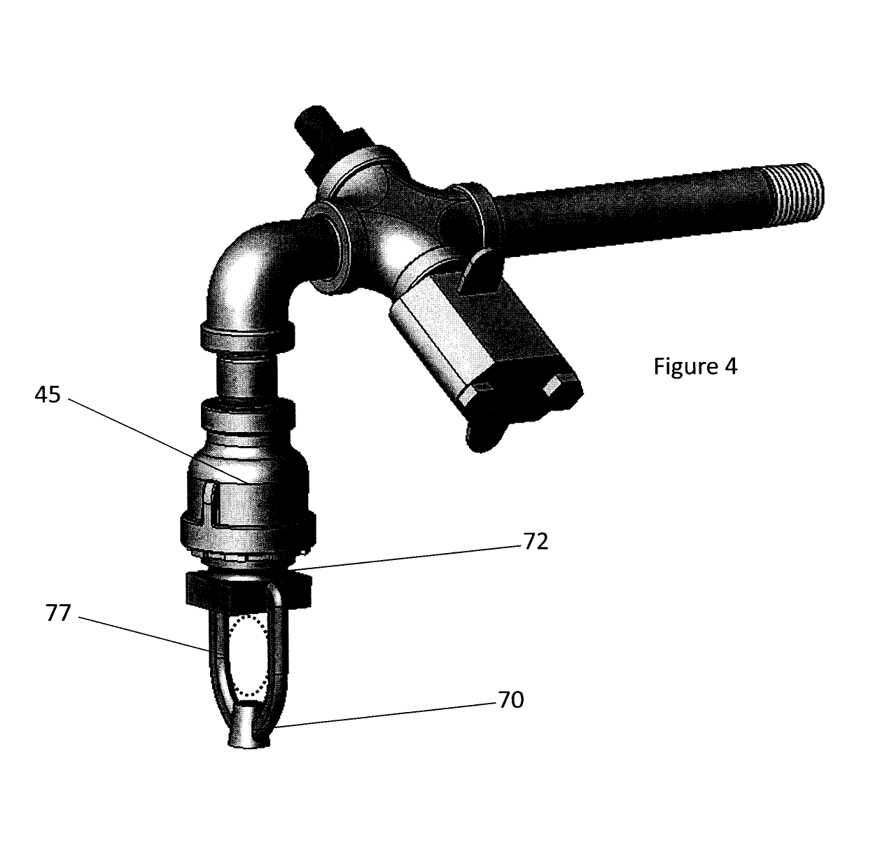

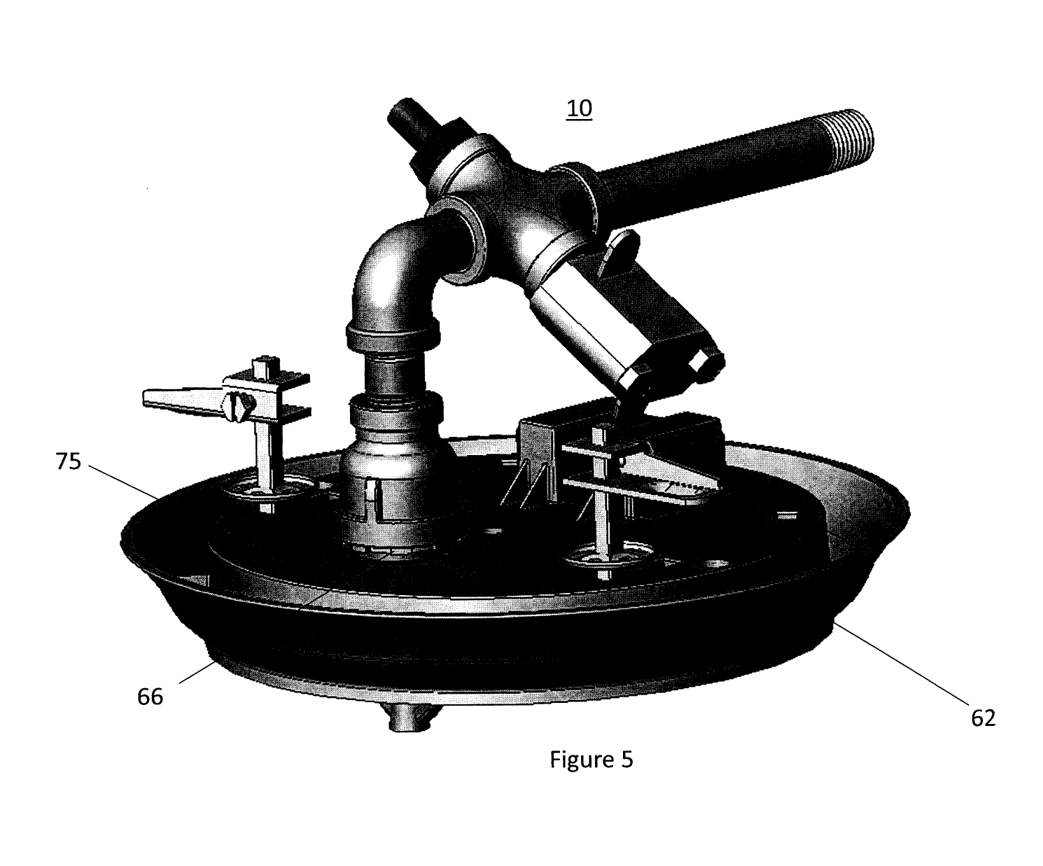

With reference to FIGS. 4 and 5 and according to one embodiment of the present invention, the extinguisher assembly 10 is shown connected to the lower housing 62 of the detector (not shown). In order to fasten the extinguisher assembly 10 to the detector 55, the spray nozzle 70 is inserted within an aperture (not shown) located in each of the spacer (not shown) and the lower housing 62. A locknut 66 is secured in between the reducer 45 and the spacer (not shown), said spacer (not shown) being flush onto an upper surface 75 of the lower housing 62. Said upper surface 75 of the lower housing 62 is shaped in such a way so as to be secured within an annular recession 72 of the spray nozzle 70, such that the extinguisher assembly 10 remains secured to the detector (not shown). Under operating circumstances, a thermal breaker (not shown) is usually located in area 77. Said thermal breaker is well known in the art, and will break when it becomes too hot. This will enable the passage of the fire retardant agent out of the spray nozzle 70 and through the redirecting slots (not shown). A worker skilled in the relevant art would appreciate that in lieu of the thermal breaker in area 77, an electronic sensor could also be utilized in communication with the PCB (not shown), without departing from the spirit and score of the invention.

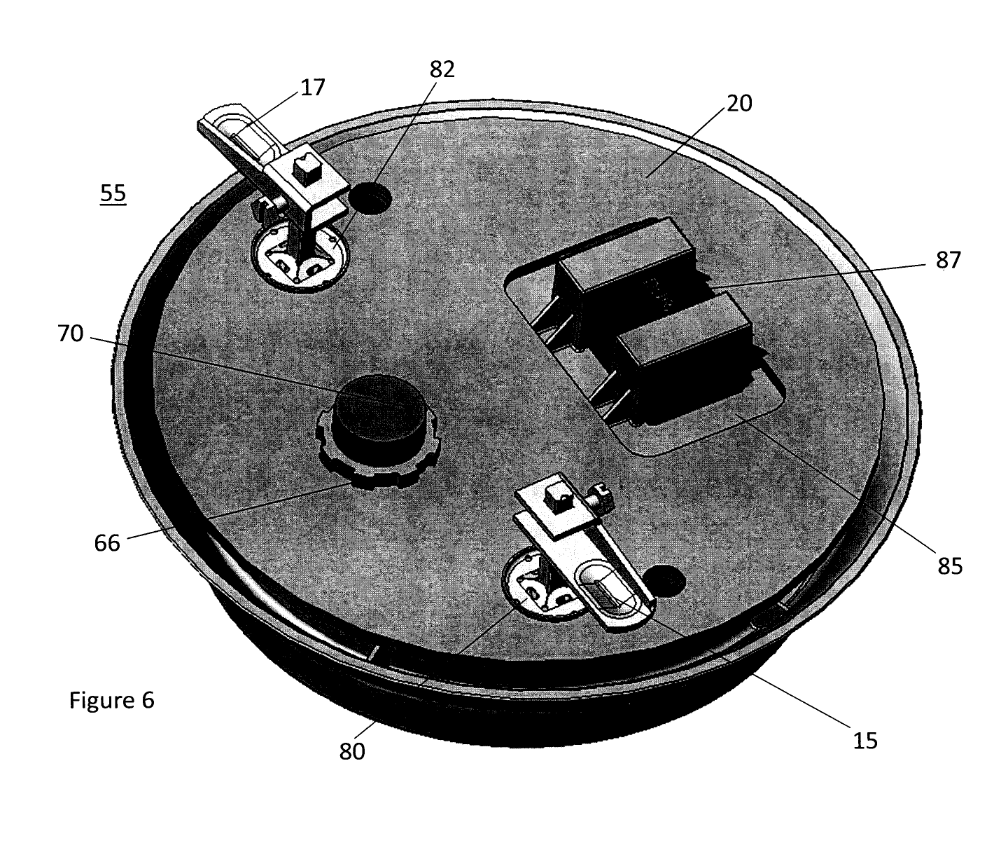

With reference to FIG. 6 and according to one embodiment of the present invention, first and second connecting members 15, 17 are secured to the spacer 20 of the extinguisher assembly by means of first and second screws (not shown) and first and second clips 80, 82. The spray nozzle 70 is shown protruding upwards from the spacer 20, connected to and within the locknut 66. A battery opening 85 is present in the spacer 20 in order to allow for the battery 87 to be easily accessible when handling the extinguisher assembly.

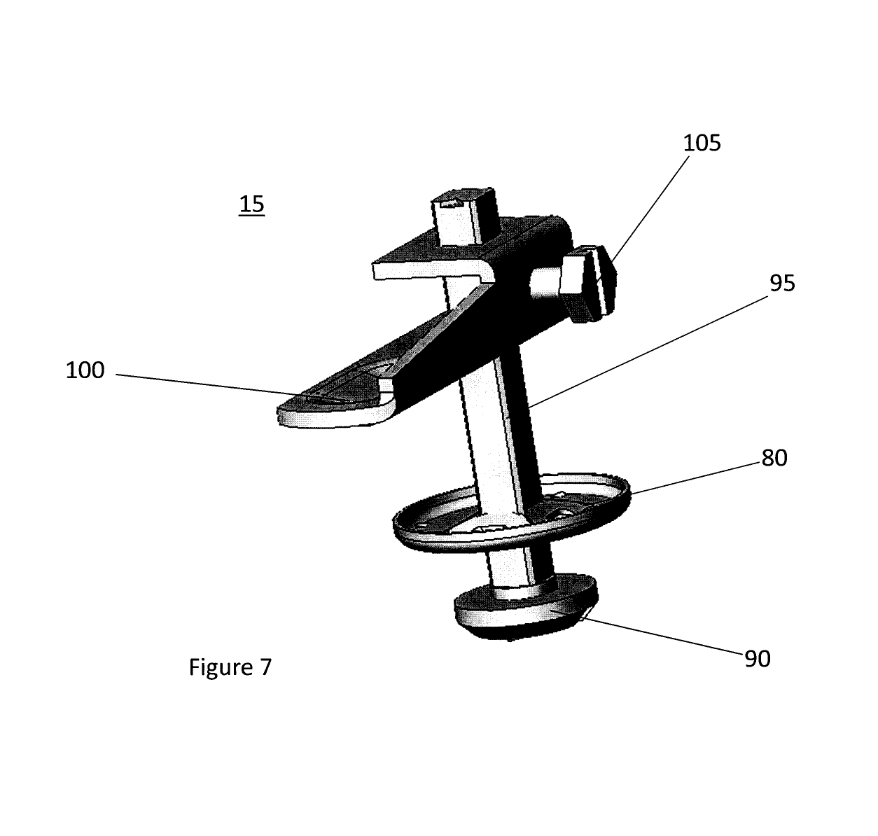

With reference to FIG. 7 and according to one embodiment of the present invention, the first connecting member 15 is shown generally comprised of a first clip 80, a first screw 90, a first slotted shaft 95 and a first pawl 100. The first pawl 100 is utilized to operatively connect to the first slotted shaft 95 such that it slides down said first slotted shaft 95 and secures the ceiling in between the spacer (not shown) and the first pawl 100. The combination of the first set screw 105 and shape of the first pawl 100 prevent said first pawl 100 from moving back upwards along the first slotted shaft 95. Meanwhile, the first clip 80 and first screw 90 provide the ability to secure the first connecting member 15 in between both the spacer (not shown) and the upper surface (not shown) of the lower housing (not shown). In order to connect the detector (not shown) to the ceiling, said detector is placed specifically in the opening created in the ceiling, having the first pawl 100 turned inward (i.e. towards the center of the detector (not shown)). Once the detector (not shown) is correctly placed, a screwdriver or other suitable tool can be used to pivot the first screw 90, which will in turn pivot the corresponding first pawl 100 outward, away from the center of the detector (not shown) such that the first pawl 100 will be flush on the interior section of the ceiling. These steps are reproduced for the second connecting member (not shown). To remove the detector (not shown), a screwdriver or other suitable tool is utilized to re-pivot the first screw 90 in the opposite direction, back towards the inside of the detector (not shown). A worker skilled in the relevant art would appreciate that the second connecting member (not shown) is comprised of the exact same components, simply located the opposite side of the first connecting member 15 and is utilized in exactly the same fashion as said first connecting member 15. A worker skilled in the relevant art would further appreciate that two spring loaded clips could be utilized here instead of the first and second connecting members, without departing from the spirit and scope of the invention. The spring loaded clips would function by pushing down on a small protruding handle which would secure the extinguisher assembly onto the drywall. By then rotating said handle, the spring loaded clip would lock and thus temporarily maintain this connection for the extinguisher assembly to remain attached to said drywall.

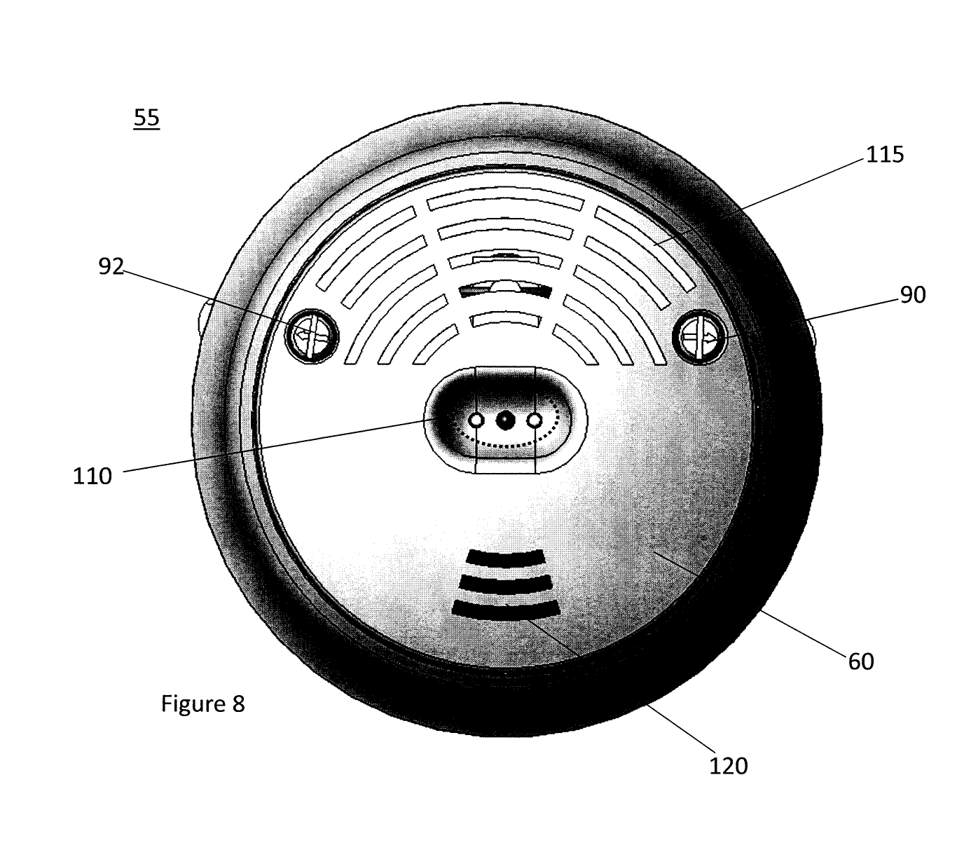

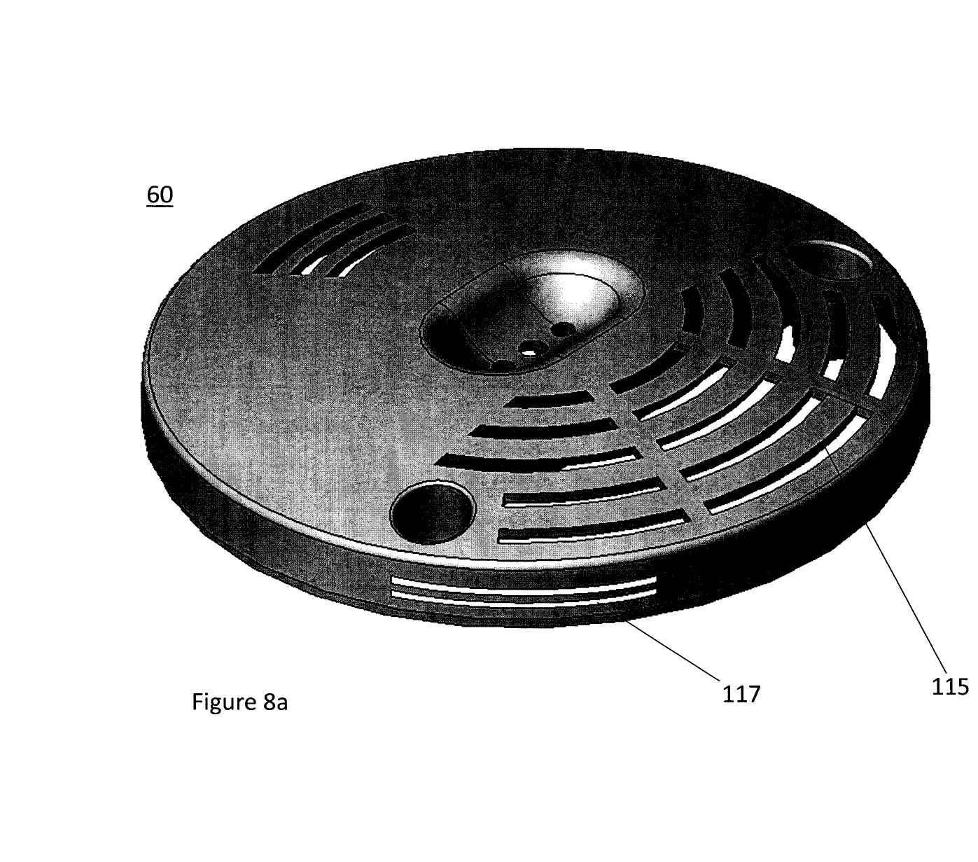

With reference to FIG. 8 and according to one embodiment of the present invention, the upper housing 60 of the detector 55 is shown generally comprised of an LED unit 110, dispersion vents 115 and speaker 120. The LED unit 110 is connected to a PCB (not shown), and will light up in different colours depending on the whether the pressure in the tank is too low, if the battery is properly functioning, if the device has enough battery power remaining, etc. As is well known in the art, the speaker 120 will sound if the detector 55 detects smoke (carbon monoxide or carbon dioxide), and can also sound under other set circumstances. Dispersion vents 115 are strategically located across half of the upper housing 60, and have approximately a 7.5° pitch in order to disperse the agent that will be expelled from the spray nozzle (not shown). While the angle of 7.5° and the semi-circular nature of the dispersion vents 115 are seen as optimal, a worker skilled in the relevant art would appreciate that various angles and different shapes of said dispersion vents 115 are also possible without departing from the scope of the invention. To unfasten the detector 55 and extinguisher assembly (not shown) from the ceiling, a screwdriver or other suitable tool is utilised to pivot the first and second screws 90, 92, corresponding to first and second connecting members (not shown) as was explained above. The arrows on the first and second screws 90, 92 serve to indicate in which way the first and second corresponding pawls (not shown) are directed such that someone operating the detector 55 would know whether said detector 55 is properly secured to the ceiling structure or not.

With reference to FIG. 8a and according to one embodiment of the present invention, an alternative embodiment of the upper housing 60 of the detector (not shown) is shown further comprised of heat slits 117, located on an outer circumference of said upper housing 60. The heat slits 117 work in conjunction with the dispersion vents 115 such that hot air created by a fire in a room will flow upwards and into the dispersion vents 115 in order to make contact with the thermal breaker (not shown). However, hot air that simply accumulates in the fire detector is often not hot enough to activate the thermal breaker (not shown) sufficiently early, such that the addition of heat slits 117 allow the hot air to flow from the dispersion vents 115, through the thermal breaker (not shown) and out of the heat slits 17, in such a manner that the turbulent air is the one that contacts the thermal breaker (not shown). As the hot turbulent air is hotter, it will allow the thermal breaker (not shown) to be activated sooner and thus be more effective. While only two heat slits 117 are shown in the present figure, it is obvious that these heat slits 117 would need to be placed side by side along the diameter of the upper housing 60 such that they substantially surround the upper housing 60 and allow for the proper amount of air to flow. A worker skilled in the art would further appreciate that more than two heat slits 117 could be positioned along the height of the upper housing 60 to maximize the opening.

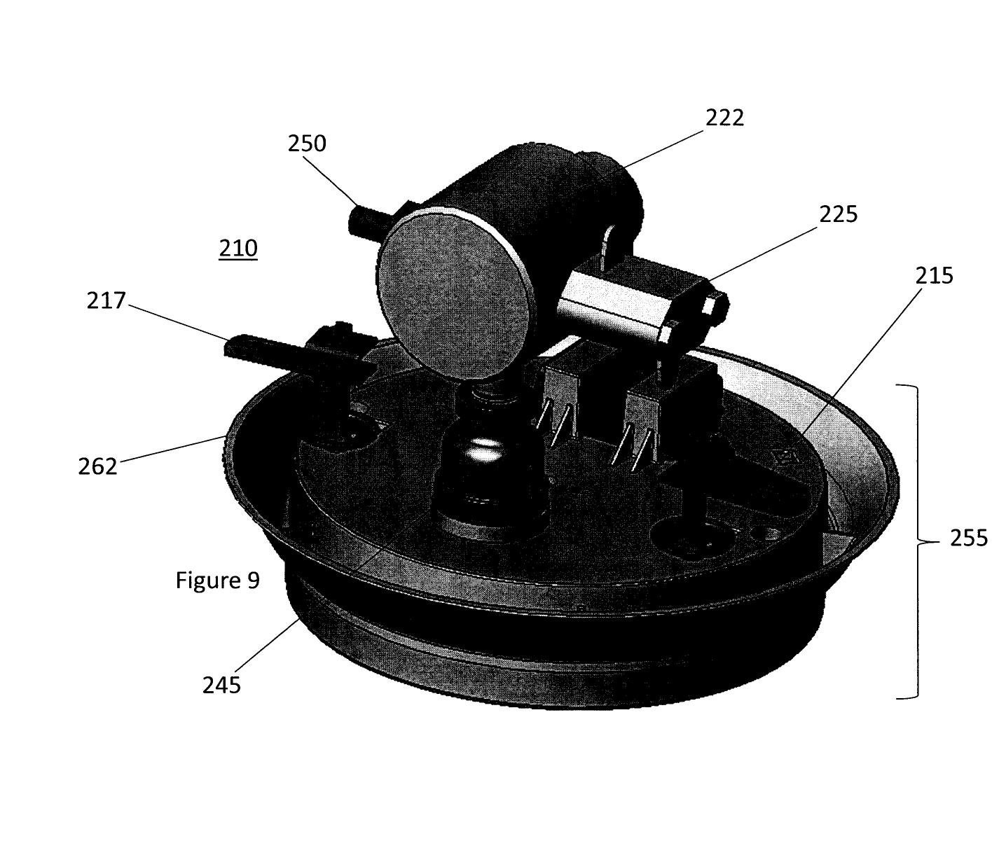

With reference to FIG. 9 and according to a second embodiment of the present invention, the extinguisher assembly 210 is shown without a spacer, tee tube or street elbow. Indeed, the tee tube and street elbow as were present in the first embodiment have been replaced with a single, 3-port adapter 222 which connects to the extinguisher tube (not shown) of the tank (not shown), as well as to the pressure switch 225 and Schrader valve 250. Said 3-port adapter 222 further connects directly into the reducer 245 such that the extinguishing agent flows from the extinguisher tube (not shown) of the tank (not shown), into the 3-port adapter 222 and through to the reducer 245. The 3-port adapter 222 reduces the amount of parts required for the extinguisher assembly 10, while not comprising any of its effectiveness. The spacer has also been removed, such that the first and second connecting members 215, 217 are fastened directly into the lower housing 262 of the fire detector 255.

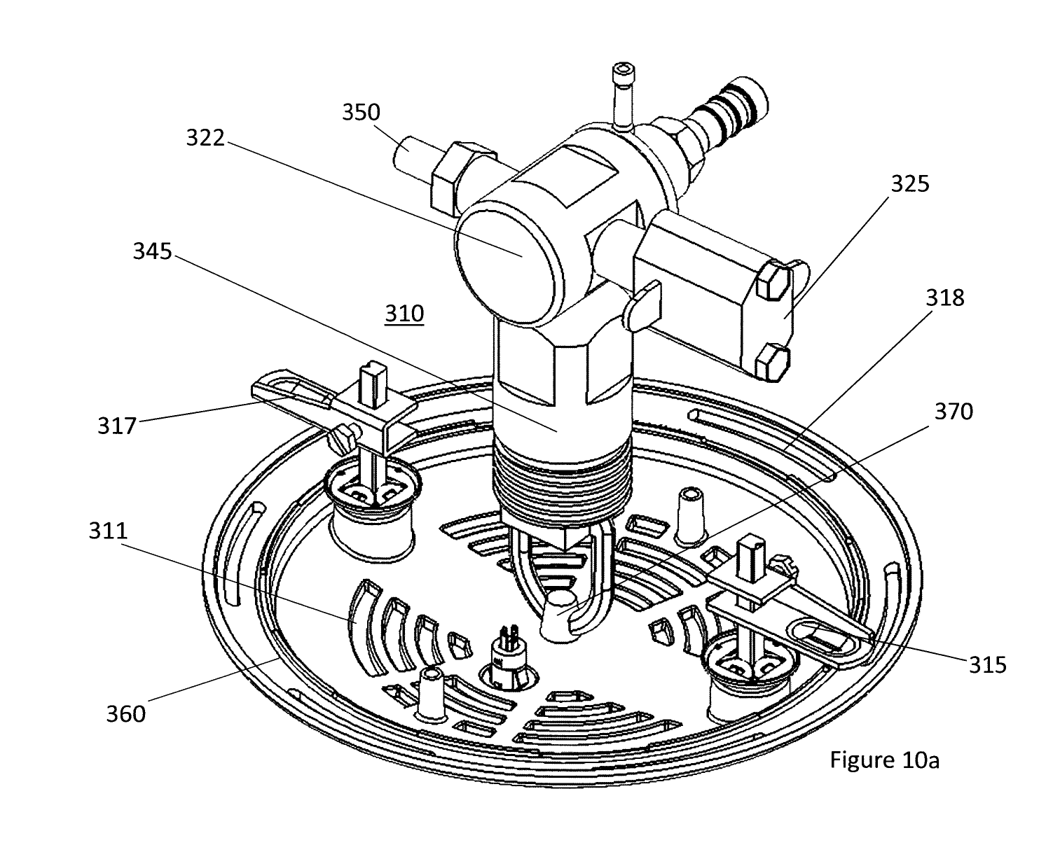

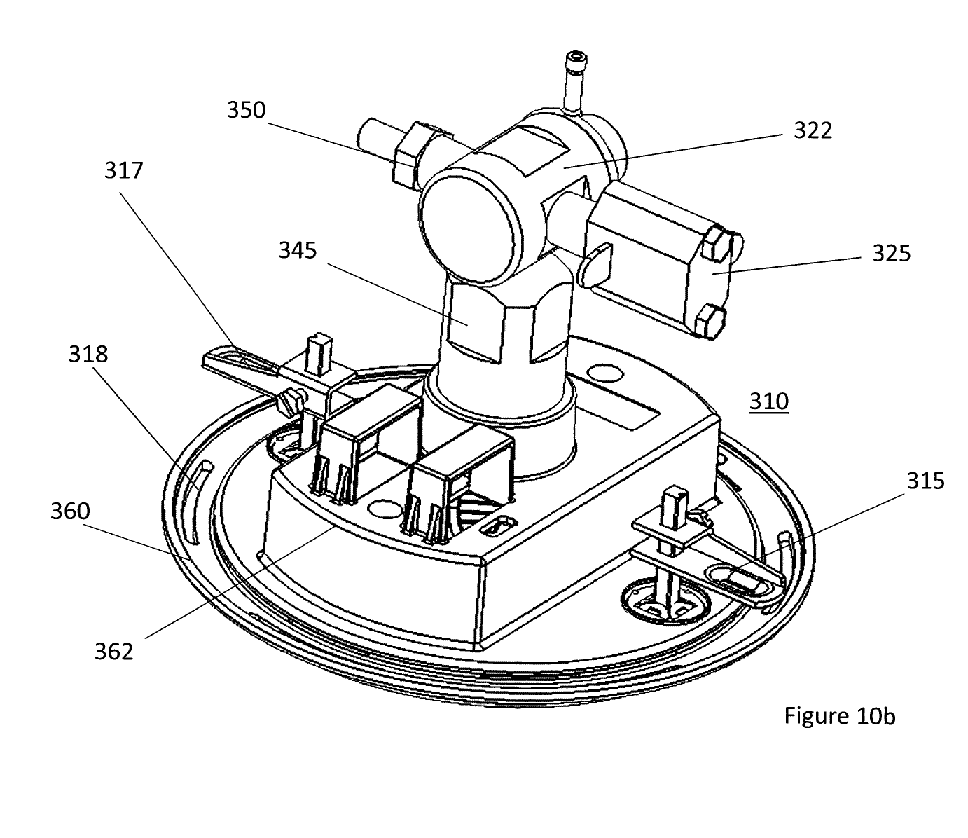

With reference to FIGS. 10a and 10b and according to a third embodiment of the present invention, the extinguisher assembly 310 is shown generally comprised of a housing 360 further comprised of dispersion vents 311 for re-directing a fire retardant agent; a spray nozzle 370 inserted within the housing 360 for dispersing the fire retardant agent through the dispersion vents 311; connecting means 315, 317, positioned on the housing 360 for securing the extinguisher assembly 310 to a structure (not shown), and an adapter 322 further comprised of a first end fastened to the spray nozzle 370 and a second end connected to an extinguisher tank (not shown). In this particular embodiment, a reducer 345 is also shown in between the adapter 322 and the spray nozzle 370 to reduce the amount of fire retardant agent coming from the tank (not shown), however, this does not need to be present and the adapter 322 can be connected directly to the spray nozzle 370. Therefore, the fire retardant agent is expelled directly from the extinguisher tank (not shown) through adapter 322, into the reducer 345 and the spray nozzle 370 and through the dispersion vents 311 which re-direct the fire retardant agent into a room. In this particular embodiment, the vents 311 have a 7.5° pitch in order to re-direct the agent, which has shown to be the optimal pitch. The embodiment also includes both a Schrader valve 350 and a pressure switch 325 connected to the adapter 322. A worker skilled in the relevant art will appreciate that the Schrader valve 350 is well known in the art; however, this particular Schrader valve 350 is loaded with sintered brass that acts as a filter in order to prevent the fire retardant agent from corroding the Schrader valve 350. Heat slits 318 are also present on the outer circumference of the housing 360 in order to dissipate heat while the extinguisher 310 is in use. A worker skilled in the art would appreciate that while FIG. 10a shows specifically the lower housing 360 only for illustrative purposes, the housing is in fact comprised of lower housing 360 and upper housing 362 as better shown in FIG. 10b. Therefore it is clearly shown that the spray nozzle 370 is secured within the housings 360, 362, and it is the upper housing 362 that is in threaded engagement with the reducer 345, whose threads are shown in FIG. 10a specifically. A worker skilled in the art would further appreciate that in the absence of the reducer 345, the spray nozzle 370 would be within the adapter 322 and the adapter 322 would be in threaded engagement with the housings 360, 362, such that the fire retardant agent would flow from the extinguisher tank (not shown) into the adapter 322 and through to the spray nozzle 370 without being reduced.

In the embodiments shown through FIGS. 1-10b, a worker skilled in the relevant art would appreciate that the housing can be secured to the adapter or another component such as the reducer which ultimately is in contact with the fire extinguisher tank. While a threaded engagement is shown, different types of connections are possible such as snap-fit, heat-resistant glue, or even molded one onto the other without departing from the scope of the invention.

Although the invention has been described above by reference to certain embodiments of the invention, the invention is not limited to the embodiments described above. Modifications and variations of the embodiments described above will occur to those skilled in the art in light of the above teachings. Moreover, with respect to the above description, it is to be repulsed that the optimum dimensional relationships for the component members of the present invention may include variations in size, material, shape, form, funding and manner of operation.

What is claimed is:

1. An extinguisher assembly for dispersing a fire retardant agent, comprising:
a. a housing further comprised of dispersion vents for re-directing the fire retardant agent;
b. a spray nozzle secured within the housing for dispersing the fire retardant agent through the dispersion vents;
c. a connecting means positioned on the housing for securing the extinguisher assembly to a structure, and
d. an adapter further comprised of a first end fastened to the spray nozzle and a second end connected to an extinguisher tank;
wherein the fire retardant agent is expelled directly from the extinguisher tank through to the dispersion vents.

2. The extinguisher assembly of claim 1 further comprised of a reducer, connected in between the spray nozzle and the adapter and in threaded engagement with the housing.

3. The extinguisher assembly of claim 1 further comprised of a Schrader valve connected to the adapter.

4. The Schrader valve of claim 3 further comprised of sintered brass to prevent the fire retardant agent from corroding the Schrader valve.

5. The extinguisher assembly of claim 1 further comprised of a pressure switch connected to the adapter.

6. The extinguisher assembly of claim 1 wherein the connecting means is further comprised of a clip connected to a slotted shaft and a pawl operatively connected to the shaft.

7. The extinguisher assembly of claim 1 further comprised of a Printed Circuit Board (PCB) and electronic sensor connected to the PCB.

8. The extinguisher assembly of claim 1 further comprised of heat slits positioned on the outer circumference of the housing.

9. The extinguisher assembly of claim 1 further comprised of a Light Emitting Diode (LED) unit for alerting an occupant of low pressure in the extinguisher tank and remaining battery life.

10. The extinguisher assembly of claim 1 wherein the dispersion vents have an optimal pitch of 7.5 degrees.

11. The extinguisher assembly of claim 1 wherein the adapter is in threaded engagement with the housing.
